(19) United States
(12) Patent Application Publication
(10) Pub. No.: US 2018/0189737 A1
(43) Pub. Date: Jul. 5, 2018

(54) AUTOMATIC ORGANIZATIONAL CHANGE PROCESSING IN A COGNITIVE NETWORKED COLLABORATION ENVIRONMENT

(71) Applicant: International Business Machines Corporation, Armonk, NY (US)

(72) Inventors: Tara Astigarraga, Fairport, NY (US); Robin L. Elaiho, Tucson, AZ (US); Agueda Martinez Hernandez Magro, Zapopan (MX); Jose Roberto Mosqueda Mejia, Puruandiro (MX)

(21) Appl. No.: 15/396,998

(22) Filed: Jan. 3, 2017

(51) Int. Cl. G06Q 10/10; G06Q 50/00

(52) U.S. Cl. CPC G06Q 10/105; G06Q 10/1095; G06Q 10/103; G06Q 50/01; G06Q 10/107

(57) ABSTRACT

Disclosed embodiments provide methods and systems for automatically reflecting organization changes in a cognitive collaboration environment. Upon transfer from a first group to a second group, a human resources system notifies a cognitive organizational system. The cognitive organizational system analyzes assets belonging to the user in his/her old group, and analyzes assets belonging to colleagues in the new group. Assets from the old group that are not commonly used in the new group are flagged, and an electronic communication is provided to the user, identifying the assets that are recommended for withdrawal by the user. The user is then given an option to withdraw from one or more of the assets.

### FIELD OF THE INVENTION

The present invention relates to automatic organizational change processing in a cognitive networked collaboration environment.

### BACKGROUND

Organizations and companies are enterprises that can have tens of thousands of employees. The enterprise can consist of hundreds, or even thousands, of subgroups, such as affiliates, engineering teams, sales teams, etc. The employees can be scattered across a country, region, or the globe. When a person is promoted, or otherwise moves to a new position within an enterprise, it can be cumbersome to determine which events, meetings, newsletters, or other items to which he/she should subscribe. There exists a need for more efficient transitioning of electronic information through a network when a person changes positions within an organizational structure.

### SUMMARY

In one aspect, embodiments of the present invention provide a computer-implemented method for automatically reflecting changes in an organizational system, comprising: obtaining a personnel change notification for a user, from a human resources system, wherein the personnel change notification indicates transition from a first group to a second group; obtaining a list of business assets currently belonging to the user; identifying one or more assets within the list that are to be flagged for possible withdrawal by the user, based on the user transitioning to the second group; communicating an indication of the one or more assets to the user; and providing an option for the user to withdrawal from the one or more assets.

In another aspect, embodiments of the present invention provide an electronic device for automatically reflecting changes in an organizational system, comprising: a processor; a memory coupled to the processor, the memory containing instructions, that when executed by the processor, perform the steps of: obtaining a personnel change notification for a user, from a human resources system, wherein the personnel change notification indicates transition from a first group to a second group; obtaining a list of business assets belonging to the user while the user was in the first group; identifying one or more assets within the list that are to be flagged for possible withdrawal by the user; and communicating an indication of the one or more assets to the user.

In another aspect, embodiments of the present invention provide a computer program product for automatically reflecting changes in an organizational system, on an electronic device, comprising a computer readable storage medium having program instructions embodied therewith, the program instructions executable by a processor to cause the electronic device to: obtain a personnel change notification for a user, from a human resources system, wherein the personnel change notification indicates transition from a first group to a second group; obtain a list of business assets belonging to the user while the user was in the first group; identify one or more assets within the list that are to be flagged for possible withdrawal by the user; and communicate an indication of the one or more assets to the user.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is an example of an organizational chart for describing embodiments of the present invention.

FIG. 2A is an example asset diagram for describing embodiments of the present invention.

FIG. 2B is another example asset diagram for describing embodiments of the present invention.

FIG. 2C is yet another example asset diagram for describing embodiments of the present invention.

FIG. 3A is an exemplary asset notification in accordance with embodiments of the present invention.

FIG. 3B is another exemplary asset notification in accordance with embodiments of the present invention.

FIG. 3C is yet another exemplary asset notification in accordance with embodiments of the present invention.

FIG. 3D shows a result of a user transitioning between groups, the result including a recommendation of groups to join.

FIG. 4 is a diagram of a system in accordance with embodiments of the present invention.

FIG. 5 is a diagram of modules in accordance with embodiments of the present invention.

FIG. 6 is a flowchart indicating process steps in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide methods and systems for automatically propagating organization changes in a networked cognitive collaboration environment. Upon transfer from a first group to a second group, a human resources system notifies a cognitive organizational system. The cognitive organizational system analyzes assets belonging to the user in his/her old group, and analyzes assets belonging to colleagues in the new group. Assets from the old group that are not commonly used in the new group are flagged, and an electronic communication is provided to the user, identifying the assets that are recommended for withdrawal by the user. The user is then given an option to withdraw from one or more of the assets. This greatly simplifies the transition of an employee between groups. It reduces clutter in the user's calendar and social media notifications by allowing the user to conveniently remove things that are no longer of interest such as calendar invites, meeting requests, and/or newsletters pertaining to the previous group. Additionally, embodiments can provide suggestions about new assets to join, based on asset membership of other members in the new group that the user is joining. Thus, the transition between groups within an organization is greatly simplified.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

Embodiments of the invention automatically reflect changes in an organizational system. A change notification for a user is obtained from a human resources system. The personnel change notification indicates transition from a first group to a second group. A list of business assets currently belonging to, or to which the user is subscribed is obtained. The assets may include electronic calendar meeting invites, email distribution lists, social media subscriptions, etc. One or more assets within the list that are to be flagged for possible withdrawal by the user are identified, based on the user transitioning to the second group. An indication of the one or more assets is communicated to the user. An option is provided for the user to withdraw from the one or more assets.

The identifying/flagging of assets for withdrawal can be executed based on geographic location of the first group and the second group (to which the user is transitioning). A first geographic location for the first group is identified, and a second geographic location for the second group is identified. Assets that are specific to the first geographic location are identified from the list of business assets. The assets that are specific to the first geographic location in the one or more assets are included within the list of assets that are to be flagged for possible withdrawal by the user.

In addition to, or instead of basing the identifying/flagging based on geography, the identifying/flagging can be executed based on average asset lists of the first and second group. A first average asset list for the first group is identified, and a second average asset list for the second group is identified. The lists are compared. Assets that are absent from the second average asset list are identified from the first average asset list based on the comparison. The assets that are absent from the second average asset list in the one or more assets are included within the list that are to be flagged for possible withdrawal by the user.

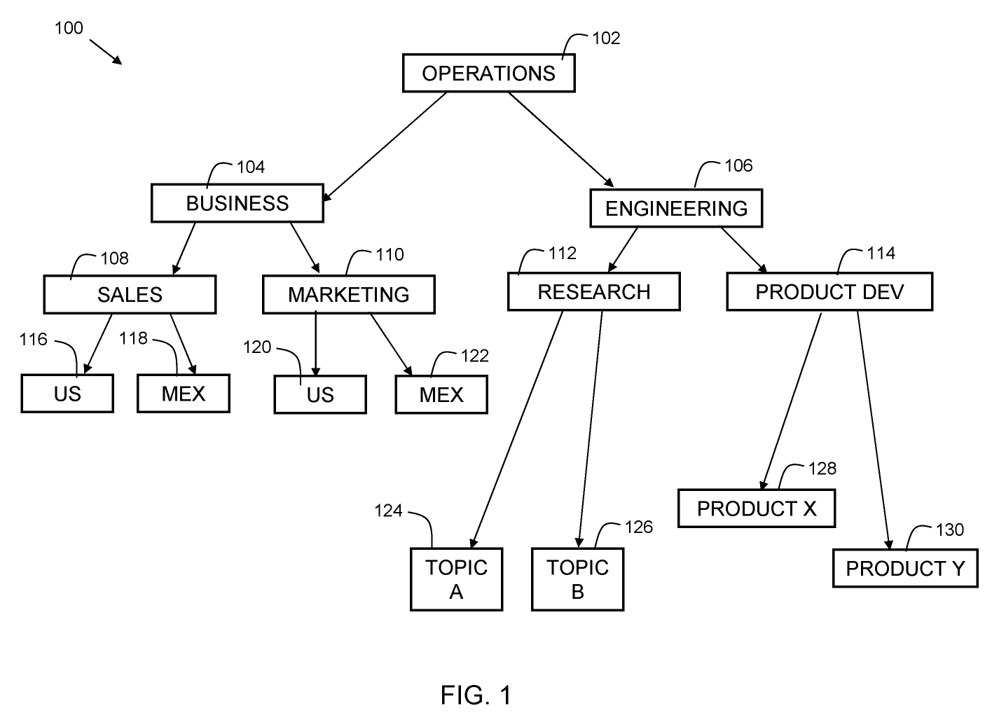

FIG. 1 is an example of an organizational chart 100 for describing embodiments of the present invention. As shown, there is operations group 102 at the top tier of the enterprise infrastructure. Below that is the business group 104 and engineering group 106. Under the business group is the sales team 108 and marketing team 110. The sales team 108 has two cohorts—one US cohort 116 and one Mexico cohort 118. The marketing team 110 has two cohorts—one US team 120 and one Mexican team 122. The engineering group 106 includes research team 112 and product development team 114. Research team 112 is split into two cohorts—a Topic A research team 124 and a Topic B research team 126. Product development team 114 is split into two cohorts—the Product X development team 128 and the Product Y development team 130.

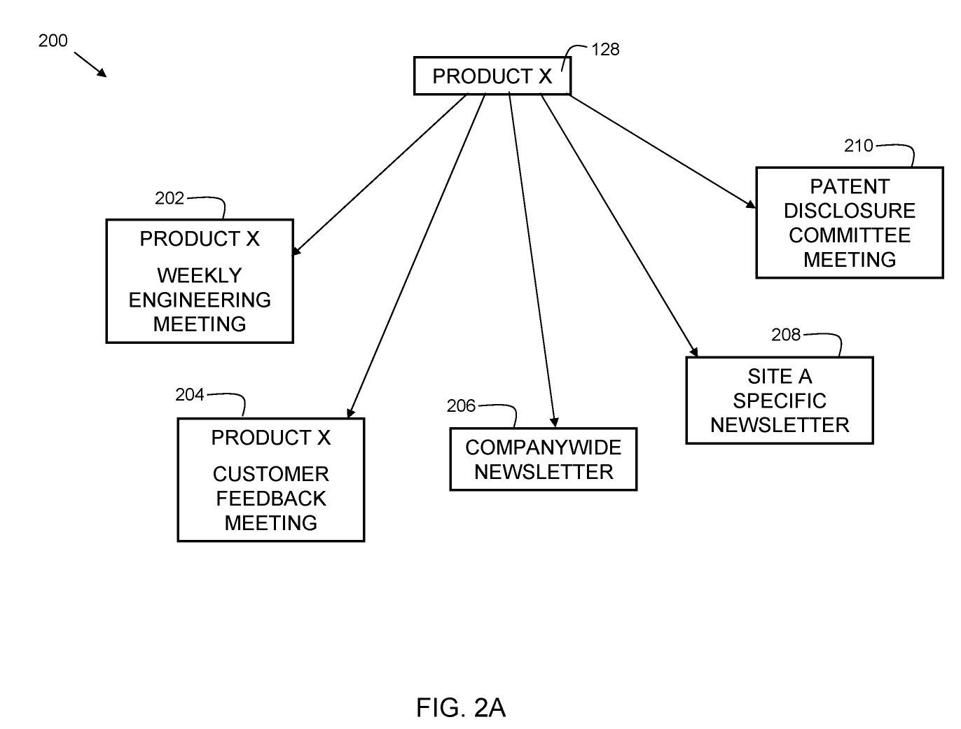

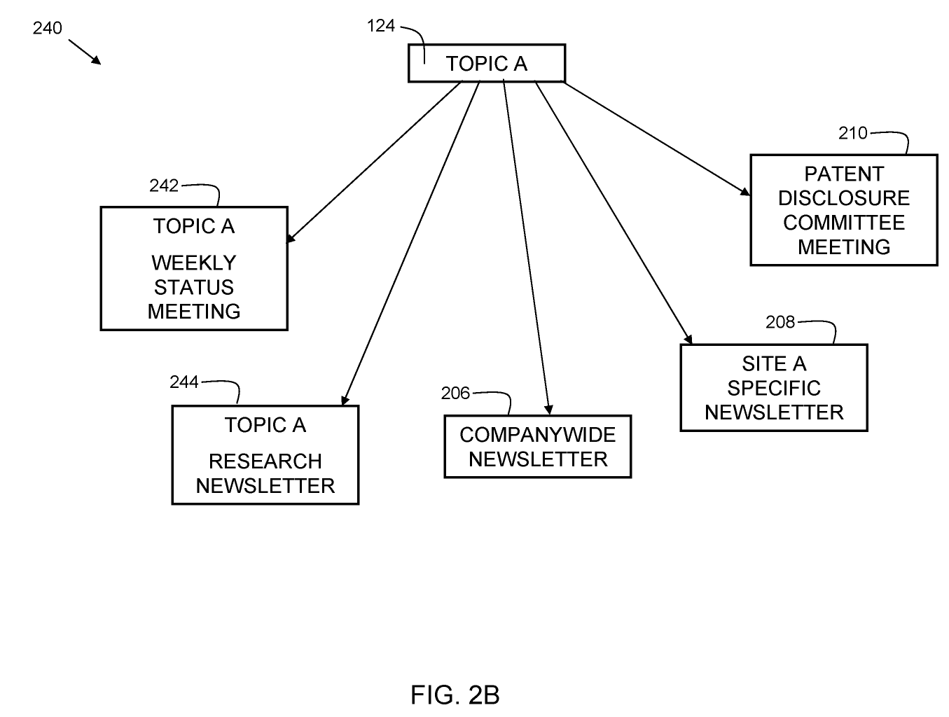

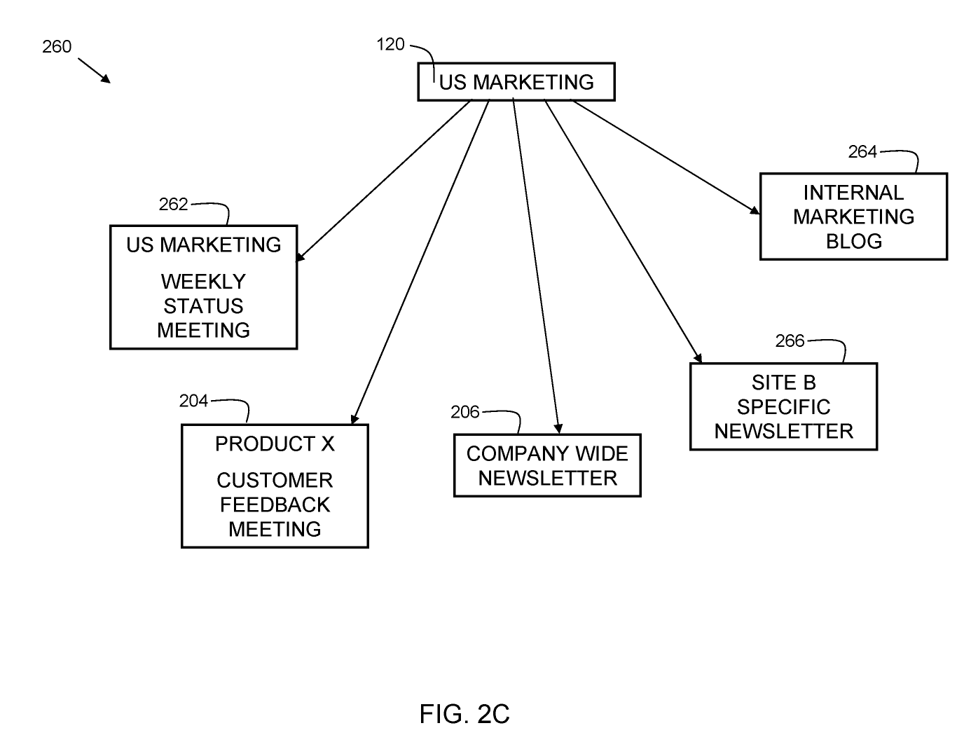

FIG. 2A shows an asset diagram 200 of a user who is a member of Product X development team 128. As part of that team, the user attends assets including a patent disclosure committee meeting 210, Product X customer feedback meeting 204, and Product X weekly engineering meeting 202. The user receives assets including a Site A specific newsletter 208 and companywide newsletter 206. Collectively, herein it is referred to that the user “subscribes” to such assets.

FIG. 2B shows an asset diagram 240 of a user who is a member of Topic A Research Team 124. As part of that team, the user attends assets including a patent disclosure committee meeting 210 and Topic A weekly status meeting 242. The user receives assets, including a Site A specific newsletter 208, companywide newsletter 206, and Topic A research newsletter 244.

FIG. 2C shows an asset diagram 260 of a user who is a member of US marketing team 120. As part of that team, the user attends assets including a US marketing weekly status meeting 262 and Product X customer feedback meeting 204. The user receives assets including companywide newsletter 206, Site B specific newsletter 266, and internal marketing blog 264.

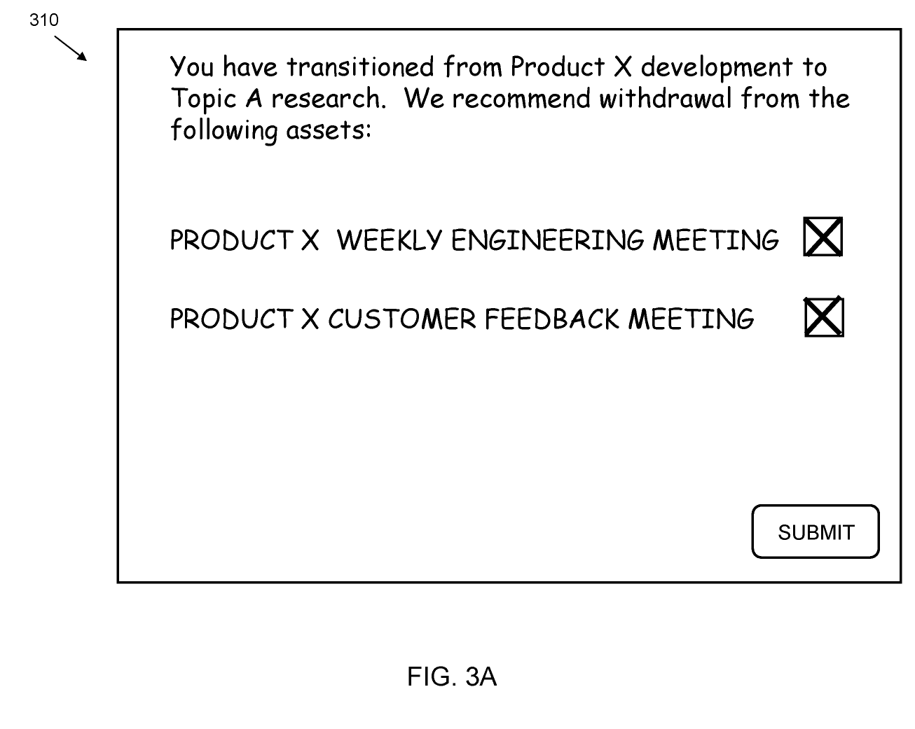

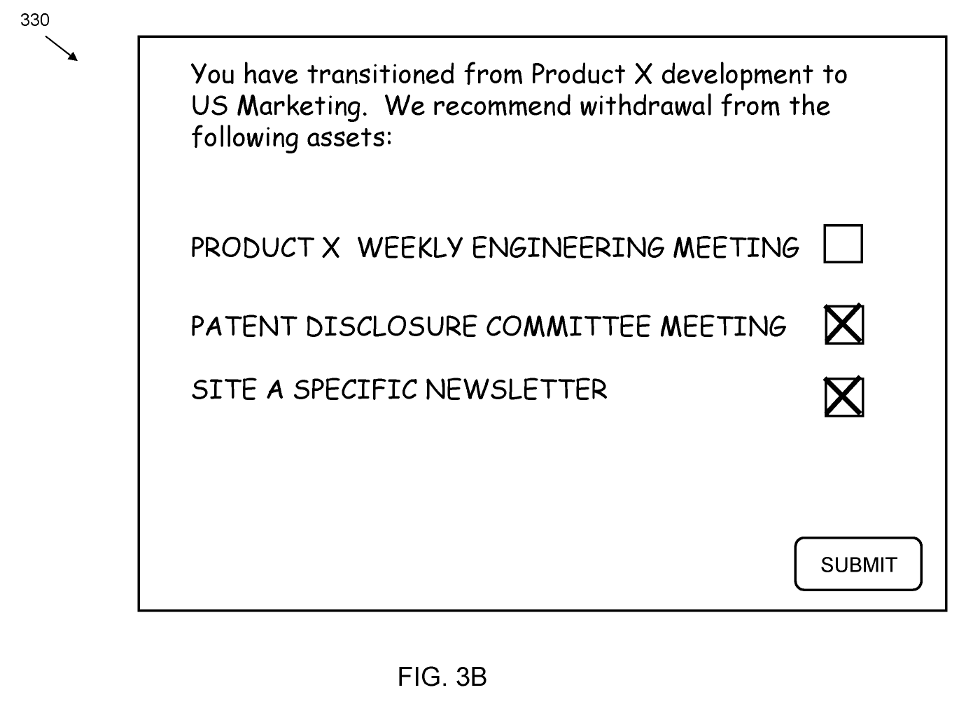

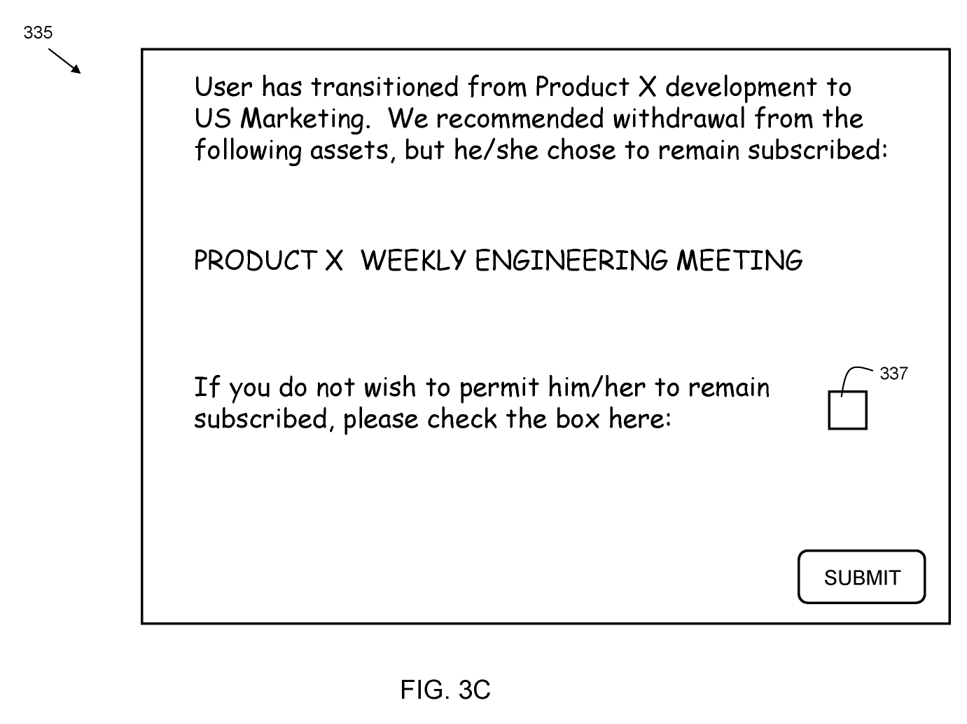

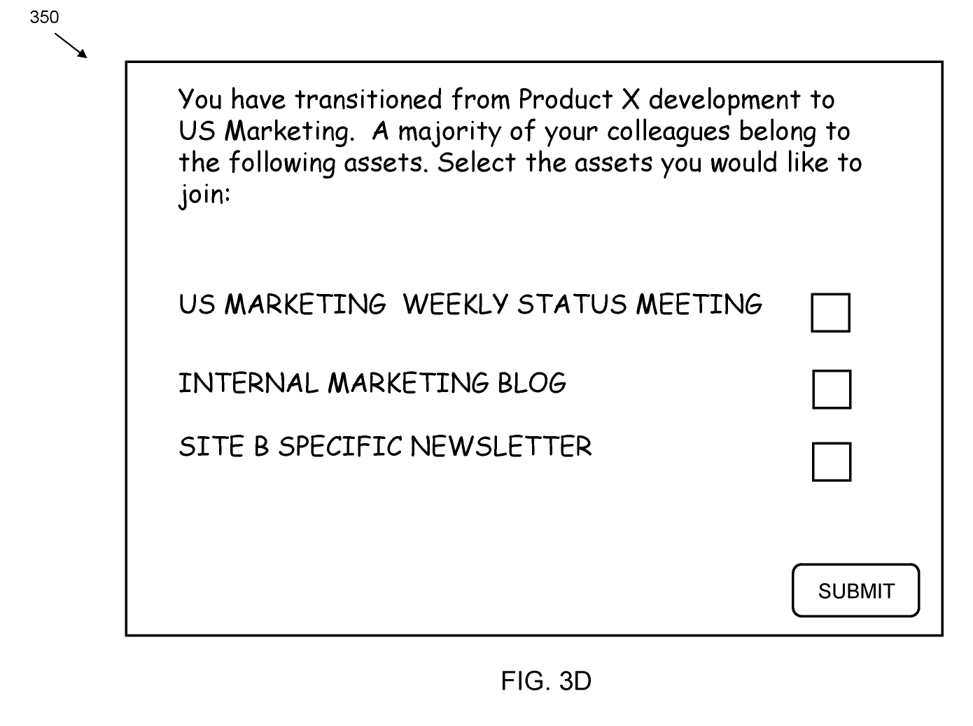

FIG. 3A shows a result of an example employee transition. In the example, the user is initially a member of the Product X development team 128, and then transitions to instead work as a member of the Topic A research team 124. Embodiments obtain a personnel change notification from a human resources system. The personnel change notification indicates the transition from Product X development team 128 to Topic A research team 124. Embodiments of the invention compare a list of the assets which on average are subscribed to by members of Product X development team 128 and a list of assets which on average are subscribed to by members of the Topic A research team 124. Based on the comparison, embodiments determine to flag Product X weekly engineering meeting 202 and Product X customer feedback meeting 204 for possible withdrawal since although they are included on average for members of the Product X development team 128, they are not included, on average, for members of the Topic A research team 124. Flagging may include associating an electronic tag with the asset(s).

A message 310 is sent to the user indicating that he/she may wish to withdraw from flagged assets. The message may be a system internal message (through an application), an email, a SMS message, or other suitable message. In some embodiments, the message provides the user with an option to withdraw from the one or more flagged assets, with a single action. As shown in FIG. 3A, in message (notification) 310, all items are automatically selected (check boxes checked). The message arrives to the user in this form. Note that the selection of the items using check boxes is an example, and other mechanisms of selection are included within the scope of the invention. With a single action, e.g., by the user pressing submit, all recommended assets are withdrawn from.

FIG. 3B shows a result of another example employee transition. In the example, the user is initially a member of the Product X development team 128, and then transitions to instead work as a member of the US marketing team 120. Embodiments obtain a personnel change notification from a human resources system. The personnel change notification indicates the transition from Product X development team 128 to US marketing team 120. Embodiments of the invention perform a first comparison of a list of the assets which on average are included for members of the Product X development team 128 and a list of assets, which on average are included for members of the US marketing team 120. Based on the comparison, embodiments determine to flag Product X weekly engineering meeting 202 and patent disclosure committee meeting 210, for possible withdrawal since although they are included on average for members of the Product X development team 128, they are not included, on average, for members of the US marketing team 120. Embodiments perform a second comparison of the geographic locations of the Product X group and the US marketing team. Site A specific newsletter 208 is flagged in response to the comparison since the Product X group is located at a first geographic location—Site A, while the US marketing team 120 is located at a second geographic location—Site B. Flagging may include associating an electronic tag with the asset(s).

A message 330 is sent to the user indicating that he/she may wish to withdraw from flagged assets. The message may be a system internal message (through an application), an email, a SMS message, or other suitable message. In some embodiments, the message provides the user with an option to withdraw from the one or more flagged assets, with a single action. In some embodiments, a user is provided with an option to withdraw from a subset of the one or more assets within the list that are flagged for possible withdrawal by the user. In response to the user withdrawing from a subset of the one or more assets within the list that are flagged for possible withdrawal, a notification is sent to an administrator for each asset of the one or more assets that are flagged for possible withdrawal, but for which the user did not withdraw. As shown in FIG. 3B, on message (notification) 330, only a subset of the recommended assets is withdrawn from. The user elected to remain subscribed to the Product X weekly engineering meeting 202, by unchecking/deselecting the associated check box.

In response to the user electing to remain subscribed to an asset even though it was recommend it be withdrawn from, embodiments may send the administrator/manager of that asset a notification that the user that left the group, but has elected to remain joined to that asset. For example, the Product X manager that hosts the weekly engineering meeting can be sent an email 335 (or other message) as shown in FIG. 3C, including a notification of the user's choice. In some embodiments, the administrator may be provided the option to override the user's choice by checking box 337. Other selection mechanisms are included within the scope of the invention. If the administrator chooses to override the user's decision, the user will be withdrawn from the asset and sent a notification of such.

In some embodiments, in response to a transition, an option (via a message) is provided for a user to join to (subscribe to) one or more assets. Assets that are absent from the average asset list of the first group, but are included in the asset list of the second group, are identified. Such assets are flagged for possible joining by the user. A message including an indication of the one or more assets flagged for possible joining is communicated to the user. An option is provided for the user to join to the one or more assets flagged for possible joining (e.g., via checkboxes, radio buttons, or other selection mechanisms).

FIG. 3D shows a result of a user transitioning between groups, the result including a recommendation of groups to join. In the example described with respect to FIG. 3B, in which the user transitioned from the Product X development team 128 to the US marketing team 120, embodiments determine that the assets, weekly status meeting 262, internal marketing blog 264, and Site B specific newsletter 266, are subscribed to on a list of an average user belonging to US Marketing Team 120, but not currently subscribed to by the user. Accordingly, embodiments provide the user with notification 350 providing the option for the user to add assets: US marketing weekly status meeting 262, internal marketing blog 264, and Site B specific newsletter 266. By default nothing is selected (i.e., checked). The user can “opt-in” for the suggested assets he/she desires (e.g., by clicking or otherwise selecting the associated boxes and pressing “submit”). Check boxes are an example selection mechanism. Others may be substituted within the scope of the invention.

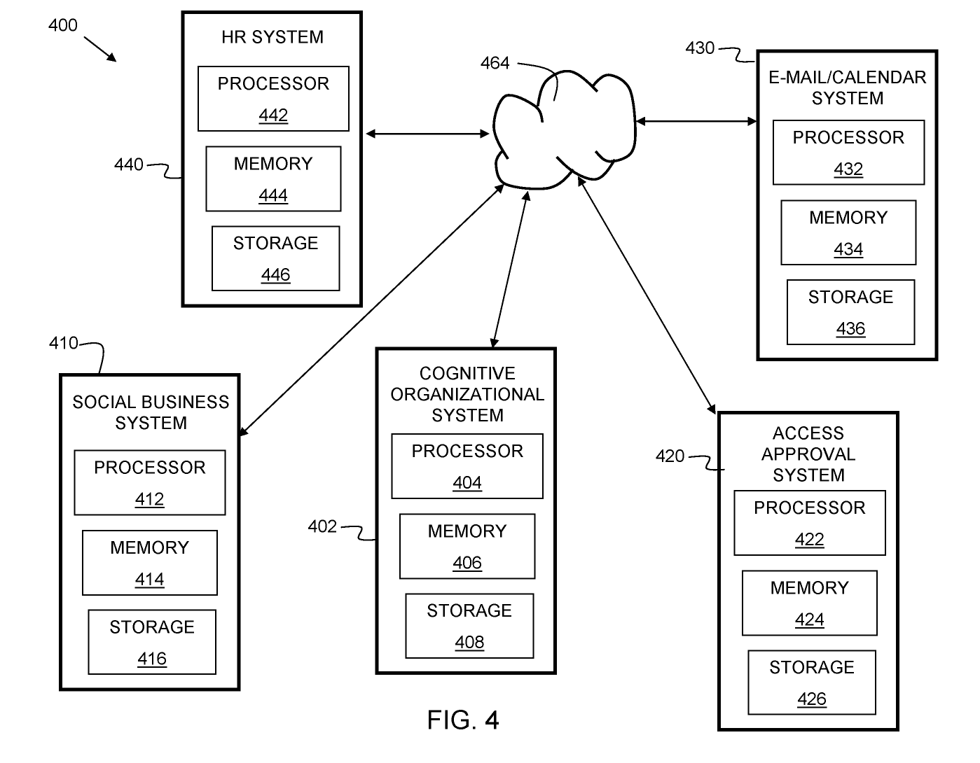

FIG. 4 is a diagram of a system 400 in accordance with embodiments of the present invention. As shown, the example system includes a cognitive organizational system 402, an access approval system 420, an email/calendar system 430, a social business system 410, and a Human Resources (HR) system 440. The systems can communicate with each other via network 464. Network 464 may include the Internet, and/or a private companywide network.

HR system 440 includes a processor 442, memory 444, and storage 446. Memory 444 includes HR information and instructions for execution by the processor to process HR changes.

Access approval system 420 includes a processor 422, memory 424, and storage 426. Memory 424 includes information relating to asset security information, such as to what level of the organizational structure are various assets allowed to be accessible. Memory 424 includes instructions, for execution by the processor 422, relating to the security information.

Email/calendar system 430 includes a processor 432, memory 434, and storage 436. Memory 434 includes information relating to meetings, events, invitations, etc. Memory 434 includes instructions for execution by processor 432 to send and manage invites to various users based on the stored information.

Social business system 410 includes a processor 412, memory 414, and storage 416. Memory 414 includes information relating to social networking within the electronic network. The social networking can include internal company blogs and/or newsfeeds, as examples. Memory 414 includes instructions, for execution by the processor 412, relating to the social networks.

Cognitive organizational system 402 includes a processor 404, memory 406, and storage 408. Memory 406 includes instructions for execution by the processor 404 to determine what assets a user should subscribe to or withdraw from. In some implementations, human resource system 440 sends a notification to cognitive organization system 402 when the HR system 440 processes a user's position change from a first group to a second group. Cognitive organizational system 440 sends an inquiry to social business system 410, access approval system 420, and email/calendar system 430. The inquiry requests information as to what assets the user currently subscribes to (as a member of the first group), and information as to what assets a typical user, on average, belongs to (as a member of the second group). The information may be based on meeting invites, distribution lists, etc. Based on the information, cognitive organizational system 440 determines what assets the user should withdraw from, and optionally, determines what assets the user should join.

Memory 406, 414, 424, 434, and 444 may include dynamic random access memory (DRAM), static random access memory (SRAM), magnetic storage, and/or a read only memory such as flash, EEPROM, optical storage, or other suitable memory. In some embodiments, the memory may not be a transitory signal per se.

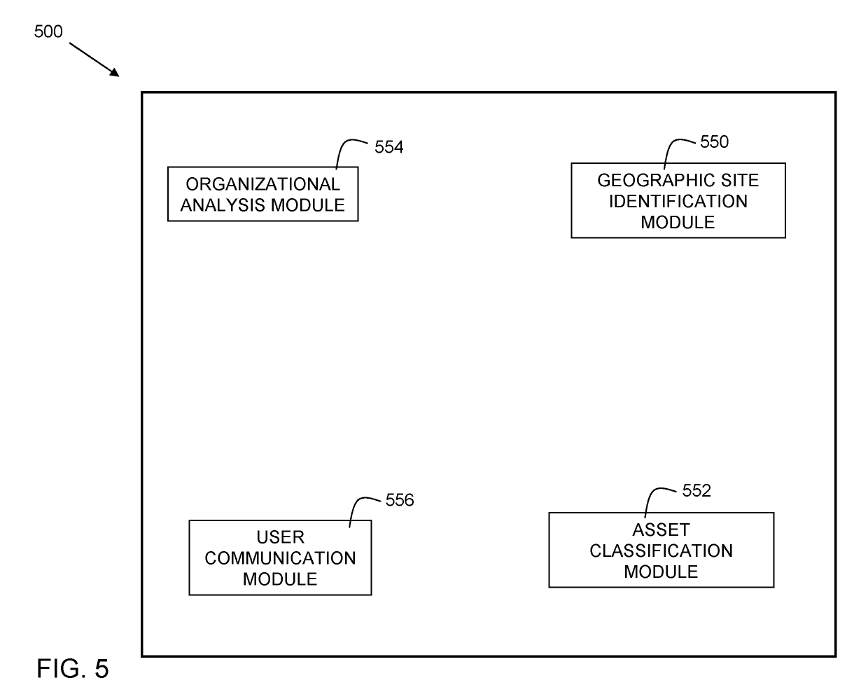

FIG. 5 is a diagram 500 of modules in accordance with embodiments of the present invention. Organizational analysis module 554 analyzes to what assets users of various groups of an enterprise subscribe. Module 554 analyzes a given position and organizational structure, and makes a determination as to what assets a user should or should not subscribe to. This can be based on averages and/or geography. Geographic site identification module 550 performs analysis of the geographic site location of a user's prior position and the geographic site of the user's new position. Based on the analysis, and if it is determined that such geographic locations are different, module 554 indicates any site-specific assets to withdraw from or join. Asset classification module 552 analyzes assets to determine classifications. In some embodiments, assets may be pre-tagged/pre-classified. In some embodiments, text can be scanned to determine a category/classification. For example, the module can scan a blog to analyze keywords to determine whether, for example, it is a marketing blog for Product X, etc. The system can use the classifications to determine its recommendations. For example, if the system recognizes a blog as pertaining to Product X, and the user is working in a Product X team, then it can be recommended to the user to subscribe to the asset (blog), if the user has not previously subscribed to such asset. User communication module 556 assembles and sends messages including the notifications having recommendations to withdraw from, or subscribe to, assets in response to a transition. Module 556 also processes the responses, for example, when a box is unchecked or checked by a user.

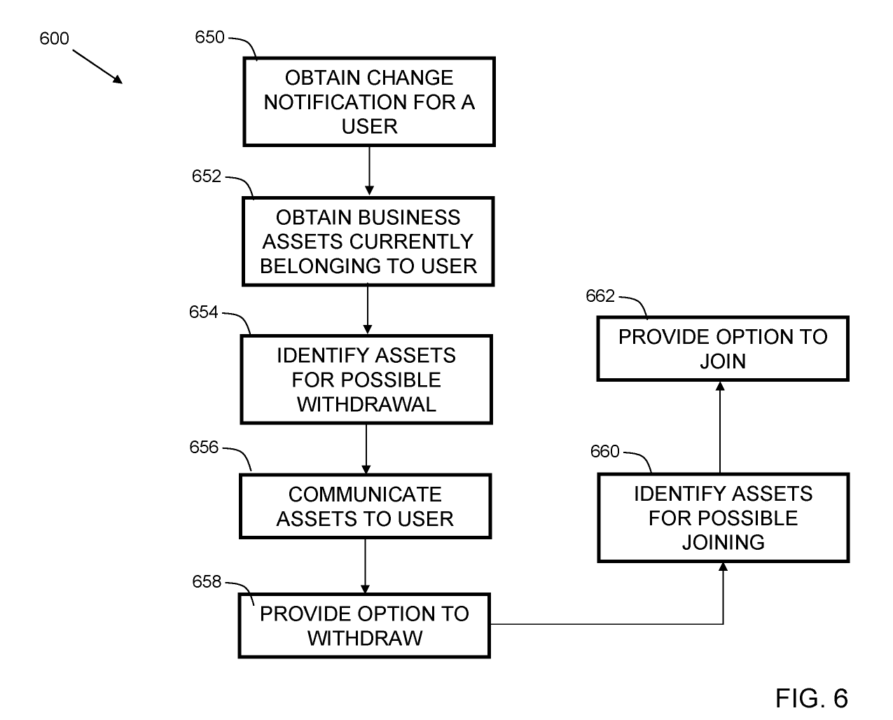

FIG. 6 is a flowchart 600 indicating process steps in accordance with embodiments of the present invention. At 650, a change notification is obtained for a user. At 652, business assets currently belonging to the user are obtained. At 654, assets for possible withdrawal are identified. At 656, the assets for possible withdrawal are communicated to the user. At 658, an option to withdraw is provided in a notification sent to the user. At 660, assets for possible joining by the user are identified. At 662, an option to join is provided in a notification sent to the user.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above-described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for automatically reflecting changes in an organizational system, comprising:
obtaining a personnel change notification for a user, from a human resources system, wherein the personnel change notification indicates transition from a first group to a second group;
obtaining a list of business assets currently belonging to the user;
identifying one or more assets within the list that are to be flagged for possible withdrawal by the user, based on the user transitioning to the second group;
communicating an indication of the one or more assets to the user; and
providing an option for the user to withdrawal from the one or more assets.

2. The method of claim 1, wherein the one or more assets includes electronic calendar meeting invites.

3. The method of claim 1, wherein the one or more assets includes an email distribution list.

4. The method of claim 1, wherein the one or more assets includes a social media subscription.

5. The method of claim 1, wherein identifying one or more assets comprises:
identifying a first geographic location for the first group;
identifying a second geographic location for the second group;
identifying, from the list of business assets, assets that are specific to the first geographic location; and
including the assets that are specific to the first geographic location in the one or more assets within the list that are to be flagged for possible withdrawal by the user.

6. The method of claim 1, wherein identifying one or more assets comprises:
identifying a first average asset list for the first group;
identifying a second average asset list for the second group;
identifying, from the first average asset list, assets that are absent from the second average asset list, and;
including the assets that are absent from the second average asset list in the one or more assets within the list that are to be flagged for possible withdrawal by the user.

7. The method of claim 6, further comprising:
identifying, from the second average asset list, assets that are absent from the first average asset list, and;
including the assets that are absent from the first average asset list in the one or more assets within the list that are to be flagged for possible joining by the user;
communicating an indication of the one or more assets flagged for possible joining, to the user; and
providing an option for the user to join to the one or more assets flagged for possible joining.

8. The method of claim 1, wherein providing an option for the user to withdraw from the one or more assets comprises providing an option for the user to withdraw, with a single action, from all of the one or more assets within the list that are to be flagged for possible withdrawal by the user.

9. The method of claim 1, wherein providing an option for the user to withdraw from the one or more assets comprises providing an option for the user to withdraw from a subset of the one or more assets within the list that are flagged for possible withdrawal by the user.

10. The method of claim 9, wherein, in response to the user withdrawing from the subset of the one or more assets within the list that are flagged for possible withdraw, a notification is sent to an administrator for each asset of the one or more assets that are flagged for possible withdrawal, but for which the user did not withdraw.

11. An electronic device for automatically reflecting changes in an organizational system, comprising:
a processor;
a memory coupled to the processor, the memory containing instructions, that when executed by the processor, perform the steps of:
obtaining a personnel change notification for a user, from a human resources system, wherein the personnel change notification indicates transition from a first group to a second group;
obtaining a list of business assets belonging to the user while the user was in the first group;
identifying one or more assets within the list that are to be flagged for possible withdrawal by the user; and
communicating an indication of the one or more assets to the user.

12. The device of claim 11, wherein the memory further contains instructions, that when executed by the processor, perform the steps of:
identifying a first geographic location for the first group;
identifying a second geographic location for the second group;
identifying, from the list of business assets, assets that are specific to the first geographic location; and
including the assets that are specific to the first geographic location in the one or more assets within the list that are to be flagged for possible withdrawal by the user.

13. The device of claim 11, wherein the memory further contains instructions, that when executed by the processor, perform the steps of:
identifying a first average asset list for the first group;
identifying a second average asset list for the second group;
identifying, from the first average asset list, assets that are absent from the second average asset list, and;
including the assets that are absent from the second average asset list in the one or more assets within the list that are to be flagged for possible withdraw by the user.

14. The device of claim 13, wherein the memory further contains instructions, that when executed by the processor, perform the steps of:
identifying, from the second average asset list, assets that the user does not belong to, and;
including the assets that the user does not belong to in the one or more assets within the list that are to be flagged for possible joining by the user; and
communicating an indication of the one or more assets flagged for possible joining, to the user.

15. The device of claim 11, wherein the one or more assets includes electronic calendar meeting invites.

16. The device of claim 11, wherein the one or more assets includes an email distribution list.

17. The device of claim 11, wherein the one or more assets includes a social media subscription.

18. A computer program product for automatically reflecting changes in an organizational system, on an electronic device, comprising a computer readable storage medium having program instructions embodied therewith, the program instructions executable by a processor to cause the electronic device to:
obtain a personnel change notification for a user, from a human resources system, wherein the personnel change notification indicates transition from a first group to a second group;
obtain a list of business assets belonging to the user while the user was in the first group;
identify one or more assets within the list that are to be flagged for possible withdrawal by the user; and
communicate an indication of the one or more assets to the user.

19. The computer program product of claim 18, further comprising program instructions executable by the processor to cause the electronic device to perform the steps of:
identifying a first geographic location for the first group;
identifying a second geographic location for the second group;
identifying, from the list of business assets, assets that are specific to the first geographic location; and
including the assets that are specific to the first geographic location in the one or more assets within the list that are to be flagged for possible withdrawal by the user.

20. The computer program product of claim 18, further comprising program instructions executable by the processor to cause the electronic device to perform the steps of:
identifying a first average asset list for the first group;
identifying a second average asset list for the second group;
identifying, from the first average asset list, assets that are absent from the second average asset list, and;
including the assets that are absent from the second average asset list in the one or more assets within the list that are to be flagged for possible withdrawal by the user.
